(19) United States
(12) Patent Application Publication
(10) Pub. No.: US 2011/0037261 A1
(43) Pub. Date: Feb. 17, 2011

(54) System And Method For Producing Electrical Power

(75) Inventors: Charles W. Champ, Asheville, NC (US); Richard Kauffman, Asheville, NC (US); Michael Tischendorf, Camas, WA (US)

Correspondence Address: SILLS CUMMIS & GROSS P.C., ONE ROCKEFELLER PLAZA, IP DEPARTMENT - 25TH FLOOR, NEW YORK, NY, 10020, US

(73) Assignee: KTCR Holding, Inc., Westport, CT (US)

(21) Appl. No.: 12/539,114

(22) Filed: Aug. 11, 2009

(51) Int. Cl. F03D 9/02; F03D 7/00; F03D 3/00

(52) U.S. Cl. 290/44; 290/52; 290/50; 290/55

(57) ABSTRACT

The disclosed technology is an electrical power system that includes a turbine, a turbine housing, an incoming channel and a generator. The turbine has at least two turbine blades and the turbine housing has at least two openings. The incoming channel directs and amplifies a flow of a working fluid at one of the openings in the turbine housing and the incoming channel is mounted in such a way that the flow of the working fluid strikes an upper portion of turbine blades. This configuration allows the turbine to rotate which in turn allows the generator to produce electrical power.

### FIELD

The disclosed technology relates to a system and method for producing electrical power, and more specifically, producing electrical power by directing and amplifying a flow of a working fluid towards a turbine.

### BACKGROUND

Growing trends in the automotive industry, as well as other industries, have been pointing toward a greener approach in regards to energy consumption and production. In this regard, every major automobile manufacturer is displaying several models of fuel efficient cars such as electric, hybrid, plug-in hybrid, and/or hydrogen-powered vehicles.

A battery electric vehicle (BEV) is an alternative fuel automobile that uses electric motors and motor controllers for propulsion, in place of more common propulsion methods such as the internal combustion engine. Electric cars are commonly powered by on-board battery packs that need to be plugged into an electrical outlet in order to be recharged. These batteries pack, however, have limited range, do not have a long life expectancy and are expensive to replace.

A hybrid electric vehicle (HEV) is a hybrid vehicle that combines a conventional internal combustion engine propulsion system with an electric propulsion system. The presence of the electric powertrain is intended to achieve better fuel economy than a conventional vehicle. A hybrid electric vehicle is a form of electric vehicle. A variety of types of HEV exist, and the degree to which they function as EVs varies as well. The most common form of HEV is the hybrid electric car, an automobile driven by a gasoline internal combustion engine and electric motors powered by batteries.

A plug-in hybrid electric vehicle (PHEV) is a hybrid vehicle with batteries that can be recharged by connecting a plug to an electric power source. It shares the characteristics of both traditional hybrid electric vehicles, having an electric motor and an internal combustion engine, and of battery electric vehicles, also having a plug to connect to the electric grid.

A hydrogen vehicle is a vehicle that uses hydrogen as its onboard fuel for power. The power plants of such vehicles convert the chemical energy of hydrogen to mechanical energy (torque) in one of two methods: combustion, or electrochemical conversion in a fuel-cell. In hydrogen internal combustion engine vehicles, the hydrogen is combusted in engines in fundamentally the same method as traditional internal combustion engine vehicles. In fuel-cell conversion, the hydrogen is reacted with oxygen to produce water and electricity, the latter being used to power an electric traction motor. Hydrogen, however, is not an energy source, but an energy carrier because it takes a great deal of energy to extract it from water. It is useful as a compact energy source in fuel cells and batteries. Many companies are working hard to develop technologies that can efficiently exploit the potential of hydrogen energy.

These above vehicles demonstrate that there is a need for more fuel-efficient or better yet, fuel-independent vehicles. But the technologies are still at their infancy and more work needs to be done to make a truly fuel-independent vehicle.

### SUMMARY OF THE DISCLOSED TECHNOLOGY

The disclosed technology may be used to build an electric vehicle that will not be restricted by an arbitrary range that is directly related to the capacity of its onboard battery pack, nor reliance upon a back up engine to recharge the batteries and extend the range. The disclosed technology gives a vehicle an almost unlimited range and will not require external recharge of its battery packs.

The disclosed technology discloses a system for producing electrical power comprising a turbine, a turbine housing, an incoming channel and at least one generator.

The turbine may have two or more turbine blades that spin on a single rotating axis. The turbine blades may be equally spaced around the axis and the tips of the blades may be parallel to the axis. The blades have a length and a curvature. In a preferred embodiment, the blade may have a backward curvature with a length of 7-21 inches. The blades tips may be weighted.

The turbine housing houses the turbine and may be cylindrical in shape. The housing may include two or more openings. These opening are used to receive and exhaust a flow of a working fluid in order to rotate the turbine.

In order to direct the flow into the housing, an incoming channel may be used. The incoming channel may direct and amplify the flow of the working fluid at the opening in the housing. The incoming channel may be mounted in such a way that the flow of working fluid strikes an upper portion of turbine blades as it enters into the housing.

A generator may be connected to the turbine for producing electrical power. The generator may be a 230/460 V, 60 Hz alternator or some other type of energy conversion system. The electrical generator may be directly or indirectly connected to the turbine. If indirectly connected, the electrical generator may be connected to the turbine via a belt/pulley system or a variable drive system.

The disclosed technology may also include an exhausting channel. The exhausting channel directs the flow of the working fluid from the second opening of the housing to the ambient atmosphere. The exhausting channel may be mounted in such a way that the flow of the working fluid expands and escapes through multiple exhaust openings.

The disclosed technology may also include a set of dampers mechanically louvered so as to modulate the velocity and volume of the incoming working fluid and deflect any excess.

A set of magnets may also be attached to the turbine and/or the turbine housing for generating electromagnetic energy and a control system may be implemented for monitoring and regulating electrical power production.

In one embodiment, the turbine may be a centrifugal turbine that has a drive shaft and three or more turbine blades attached to the drive shaft. The three turbine blades may be backward-curved blades. In this embodiment, the turbine may have two or more openings. The first opening may receive a flow of a working fluid and the second opening may exhaust the flow of the working fluid. The flow may be received from an incoming channel that directs and amplifies the flow of the working fluid at the first opening. The incoming channel may be mounted in such a way that the flow of the working fluid strikes an upper portion of turbine blades. The turbine may also be connected to at least one generator for producing electrical power.

In another embodiment, the turbine housing may include three openings. The first opening is for receiving a flow of a working fluid, the second opening is for exhausting the flow of the working fluid and the third opening is for receiving a recycled flow from a flow diverter. That is, the flow diverter directs the flow exhausted from the second opening to the third opening. This embodiment also may include an incoming channel for directing and amplifying working fluids at a first opening with the incoming channel being mounted in such a way that the working fluids strike an upper portion of turbine blades. A generator may also be connected to the turbine for producing electrical power.

In another embodiment, the system may include an exhausting channel. The exhausting channel directs the flow of the working fluid from the second opening to the ambient atmosphere. The exhausting channel may be mounted in such a way that the flow of the working fluid expands and escapes through multiple exhaust openings. The exhausting channel may also minimize turbulence and back pressure associated with exhausting working fluids. This embodiment also includes a turbine housing and a turbine and connected to a generator for producing electrical power.

The above systems may be incorporated and mounted into a moving vehicle. That is, the turbine and turbine housing may be mounted within the vehicle near the front of the vehicle. While the incoming channel may be located in a front opening mounted between the headlights of the moving vehicle. The generator(s) may be mounted behind the turbine and turbine housing and slightly below the axis of the turbine. The generator may be connected via a pulley/belt system to opposing ends of the turbine shaft with a pulley/belt ratio of 3:1. The exhaust channel may also be mounted behind the turbine and turbine housing. The exhausting channel may also include a series of interconnected channels that allows the working fluid, in this case air, to expand and escape through openings. These openings may be located near a vehicle's windshield, beneath the floor panels and/or through front wheel wells and fenders. The exhausting channel may eliminate any turbulence and back pressure that might otherwise be the result of the large volume of escaping air.

Other devices which may be incorporated into the moving vehicle include wheel hub motors, battery packs for storing electrical power produced from the generator, solar panels attached to a roof of the vehicle, programmable logic controllers for controlling power consumption and generation, variable transformers, regenerative drives, phase converters, electrical contactors, industrial inverters, transfer switches, disconnects, 3 pole motor/generators, 4 pole polyphase induction motor/generators, 4 pole polyphase induction squirrel cage motor/generators, capacitor banks and combinations thereof.

A method for producing electrical power comprises the steps of first directing and amplifying a flow of a working fluid at a turbine within a turbine housing. The flow of working fluid may strike an upper portion of turbine blades. This, in turn, produces electrical power via the rotation of the turbine. The flow is then exhausted and expanded out of the turbine housing.

### BRIEF DESCRIPTION OF THE DRAWINGS

FIG. 1 shows a perspective view of the preferred embodiment of the disclosed technology;

FIG. 2a shows a perspective view of the turbine and turbine housing of the disclosed technology;

FIG. 2a shows a side view of the turbine and turbine housing of the disclosed technology;

FIG. 3 shows a perspective view of generators mounted on a frame;

FIG. 4 shows a block drawing of the preferred embodiment of the disclosed technology using a belt/pulley system;

FIG. 5 shows an fluid flow diagram representing a preferred embodiment of the disclosed technology; and

FIG. 6 shows a perspective view of a second preferred embodiment of the disclosed technology;

FIG. 7 shows a top view of a moving vehicle having the disclosed technology mounted within its frame;

FIGS. 8a-b show a perspective view of a turbine housing and turbine according to another embodiment of the disclosed technology; and

FIG. 9 shows a perspective view of another preferred embodiment of the disclosed technology.

### DETAILED DESCRIPTION

The disclosed technology is a system and method that uses a uniquely designed turbine to produce electrical power. The device can be used with low to high flows of a working fluid to drive, directly or indirectly, electrical generators. The driving fluids rotate the turbine so that the turbine has sufficient revolutions per minute and torque to create a rotating force necessary to power an electrical generator, an alternator and/or a wheel hub motor.

The technological enhancements and capabilities disclosed herein would be beneficial to any application were a working fluid is flowing abundantly. In one embodiment, the disclosed technology is capable of generating electricity by utilizing wind that is produced by a vehicles forward momentum. In another embodiment, the disclosed technology is capable of generating electricity by utilizing water flows produced by a river's current.

The device can be manufactured using a wide variety of materials. The efficiency of the device varies based on the weight and dimensions of the materials and the fluid involved in the driving of the turbine.

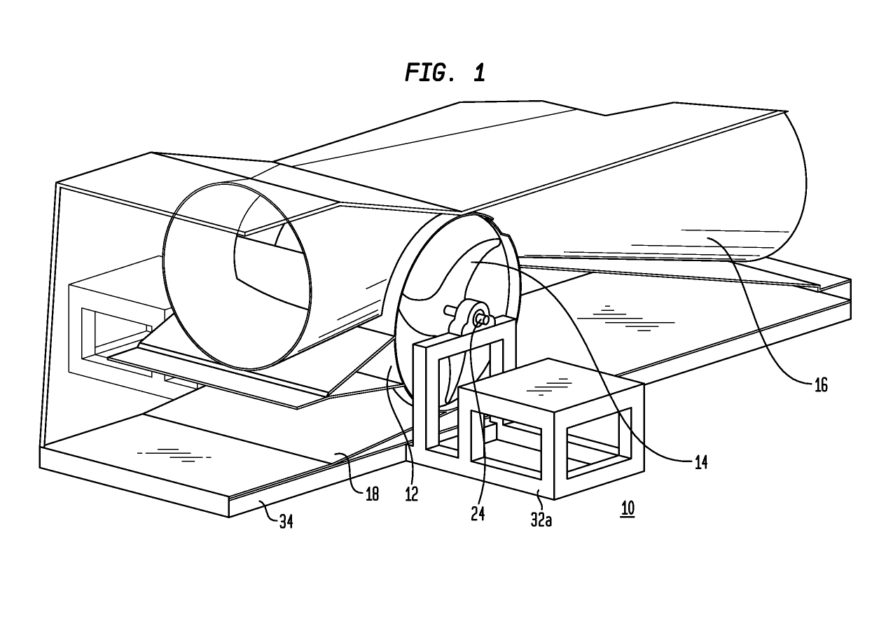

As shown in FIG. 1, the system 10 includes a turbine housing 12, a turbine 14, an incoming channel 16 and an exhausting channel 18. The size of the unit is variable dependent on the electrical output needed.

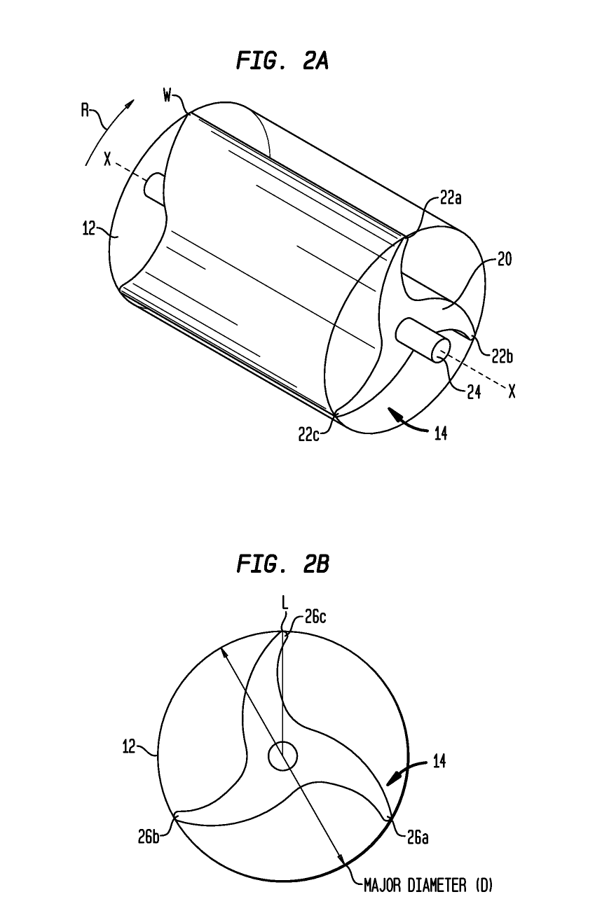

The turbine housing 12 and turbine 14 is a modified centrifugal fan system. As shown in FIG. 2a-b, the turbine 14 has a turbine wheel 20 composed of a number of turbine blades 22a-c mounted around an axel or drive shaft 24. The drive shaft 24 passes through the turbine housing 12 and may connect at its ends to an electrical generator (not shown in this figure and will be more fully discussed below).

The turbine blades 22a-c can be straight, slanted in the direction of the working fluid (forward-curved), or slanted opposite the direction of the working fluid (backward-curved or backward-inclined). In the preferred embodiment, backward-curved blades are used.

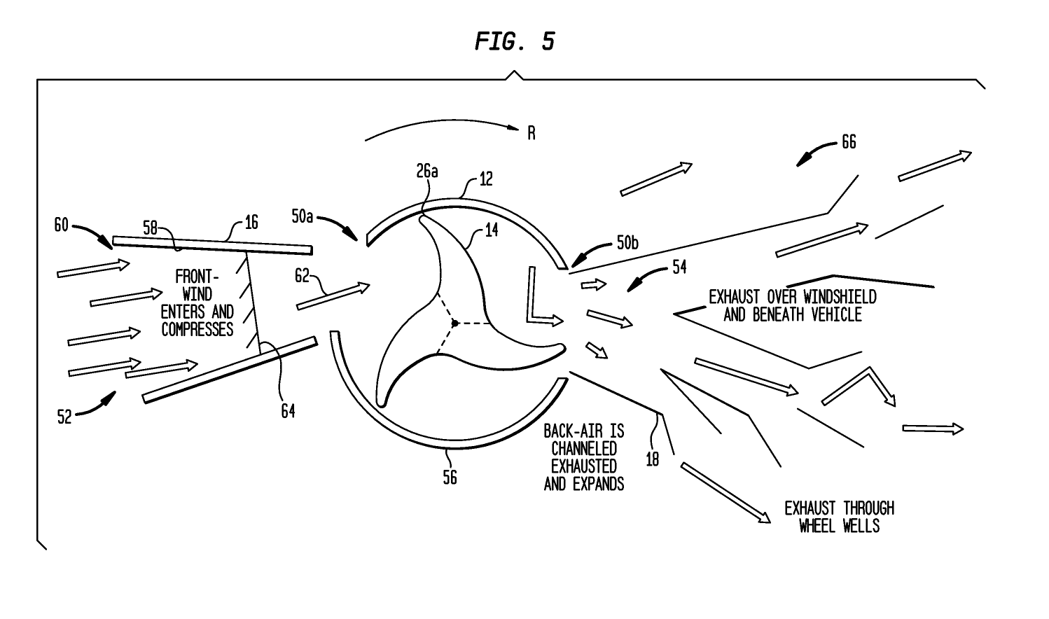

As shown in FIG. 5, backward-curved blades 22a-c curve against the direction of the fan wheel's rotation R. The backward curvature mimics that of an airfoil and provides good operating efficiency with relatively economical construction techniques. This is true because, as the wind force 52 passes over the top of the blade 22a-c, the wind force creates a negative pressure creating lift. As the turbine 14 rotates, the tips 26a-c of the blades 22a-c are exposed to a direct positive wind force which drives the turbine into rotation about an axis X. As each blade 22a-c is exposed to this alternating negative-positive set of pressures, momentum is gained until a mass torque centripetal force reaches a maximum number of revolutions per minute which is maintained as long as the wind force 52 remains constant. If the wind force 52 varies in speed or volume or both, the maximum number of revolutions per minute will vary with each set of conditions. The shape (length and curvature), the number and location of blades 22a-c will also vary the revolutions per minute.

In practice, any wind force 52 sufficient to provide the necessary mass torque centripetal force will rotate the turbine 14. The turbine mass torque centripetal force requirement includes the necessary wind force 52 to operate a mechanical electrical device 30a-b for the purpose of producing electrical as the end result. This requires the design and manufacture of the turbine 14 to meet the torque and rotational speed parameters of the mechanical electrical device 30a-b. Centripetal force can be increased or decreased based on the diameter D of the turbine 14 at any selected wind force speed or volume or both. The centripetal force created by the wind force 52 for a turbine 14 allows for the required operational torque to be met or exceeded.

Backward curved turbines 14 have a high range of specific speeds but are most often used for medium specific speed applications—high pressure, medium flow applications. Backward-curved turbines 14 are also much more energy efficient than radial blade fans and so, for high horsepower applications may be a suitable alternative to the lower cost radial bladed fan.

As shown in FIG. 2a-b, the turbine 14 includes two or more scythe shaped blades 22a-c in a horizontal or vertical plane where it rotates around and in the same plane of a single axis X. The wind turbine 14 may be approximately 14-42″ in diameter (D) and 9-27″ wide (W) but size is dependent on application and can be designed and manufactured with a variety of lengths and general circumferences. Each elongated blade 22a-c has a length (L) of approximately 7-21 inches and is equally spaced around the core axis X. The tips of the blades 26 are elongated and are parallel to the rotating axis X. The blade ends 24 may be weighted and the turbine wheel 20 may be weighted with concentric rings (not shown) to increase centripetal force.

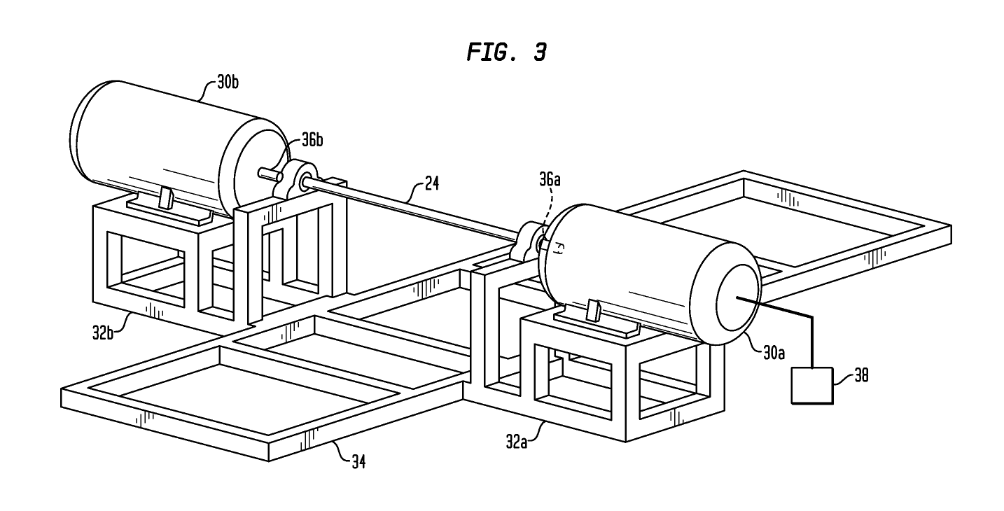

The turbine 14 determines the speed of the generator motors 30a-b and the extent to which this speed can be varied. As shown in FIG. 3, the turbine 14 can be linked directly to the shaft 36a-b of an electric motors 30a-b, respectively. This means that the turbine wheel speed is identical to the motor's rotational speed. With this type of fan drive mechanism, the fan speed cannot be varied unless the generator torque is adjusted.

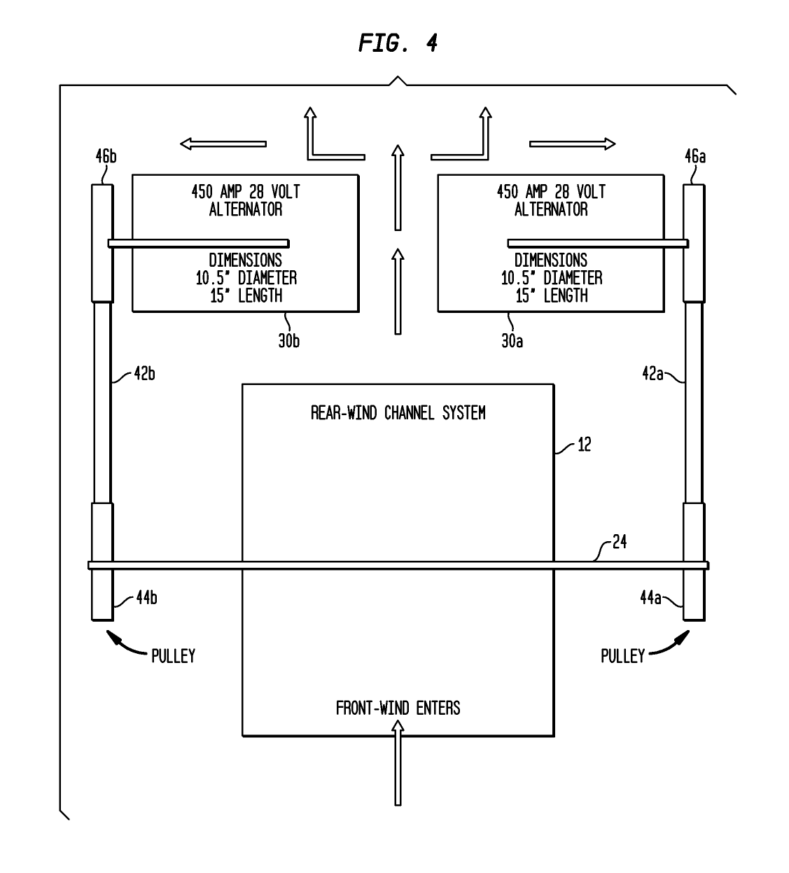

In FIG. 4, the turbine shaft can also be linked indirectly to electric generators (e.g., a 230/460 V, 60 Hz alternator) via a belt/pulley system 40a-b. These belt driven turbines can use multiple belts 42a-b that rotate in a set of sheaves 46a-b and 44a-b mounted on the motor shaft 36a-b and the fan wheel shaft 24, respectively. The belts 42a-b transmit the mechanical energy from the turbine shaft 24 to the generator 30a-b. The generator speed depends upon the ratio of the diameter of the motor sheave 46a-b to the diameter of the turbine sheave 44a-b, e.g., a 2:1 ratio, 3:1 ratio, ect.

The turbine 14 can also use a variable drive system (not shown) that uses hydraulic or magnetic couplings (between the turbine drive shaft and the motor shaft) that allows control of the turbine speed independent of the generator speed. These speed controls are often integrated into automated systems to maintain the desired wheel speed. An alternate method of varying the fan speed is an electronic variable-speed drive which controls the speed of the motor driving the fan. This offers better overall energy efficiency at reduced speeds than mechanical couplings.

As shown in FIG. 5, the disclosed technology modified a standard centrifugal fan housing by eliminating air intake on the side of the fan wheel. By eliminating the side intake, the air flow no longer enters the turbine from the side of the unit where it use to make a 90 degree turn. Instead the housing or shroud 12 was modified so that two or more openings 50a-b were placed on the outer skin 56 of the housing 12. Now, the air flow 52 can directly flow into the housing 12 and be directed to the tips 26a-c of the blade 22a-c itself. The wind force 52 necessary to operate the turbine can either be created by nature or machines.

The wind force 52 may be shaped, directed and/or controlled for volume and velocity through a straight wind channel, a louvered wind channel, a nozzle-type wind channel or combinations thereof. The wind channel 16 may channel wind with or without fans or blowers and can be designed as an angular, directional single direction system and/or directional return wind force system.

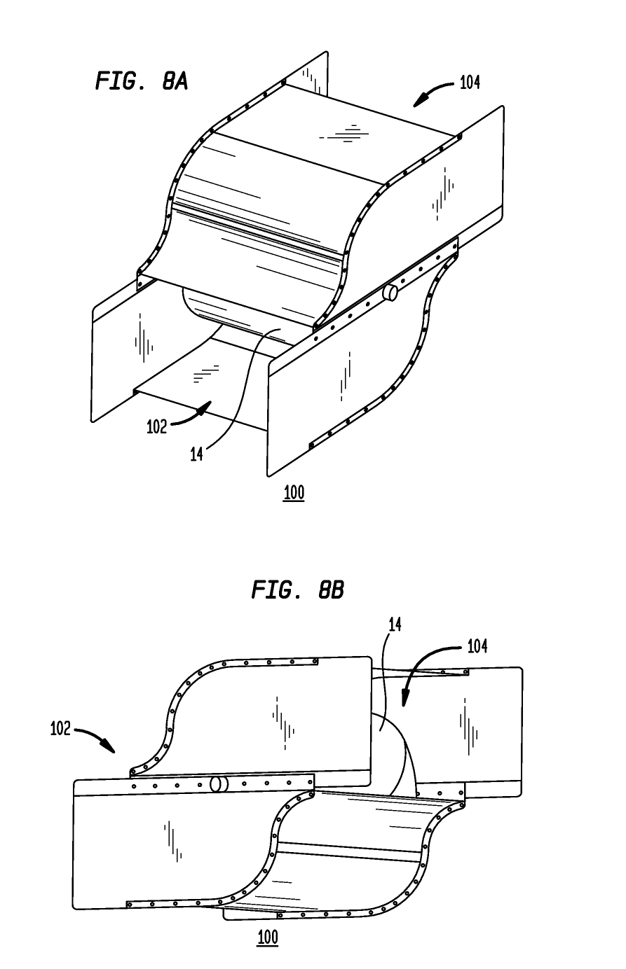

The nozzle-type wind channel 16 may be connected directly to fan or blower systems allowing for the compacting or concentrating of air being directed at the specified target onto the turbine 14 to increase centripetal force and, thereby, overcome the operational torque requirements of electrical motor/generators and electrical alternators 30a-b. These nozzle-type wind channels 16 effectively amplify the wind speed by a factor of approximately 2-5. FIGS. 8a-b shows a turbine housing 100 that includes a straight forward wind channel 102 and a straight rearward wind channel 104.

In the preferred embodiment, the wind channel or incoming channel 16 is nozzle-type wind channel and has a smooth internal finish 58 and a front opening 60 that is approximately 30″ by 30″ (or 900 square inches). The incoming channel can be reduced both in width and depth to a rear opening 62 that is approximately 8″ wide by 10″ deep (or 180 square inches).

Turbine dampers 64 are used to control flow into and out of the turbine housing 12. The dampers 64 may be installed on the incoming channel 16 or on the outlet side of the turbine, or both. Dampers 64 on the outlet side impose a flow resistance that is used to control the flow. Dampers on the inlet side (not shown) are designed to control airflow and to change how the flow enters the turbine housing. Inlet dampers reduce turbine energy usage due to their ability to affect the airflow pattern into the turbine housing. The dampers 64 may be mechanically louvered so as to modulate the velocity and volume of the incoming air and deflect any excess.

The turbine 14 and turbine housing 12 will be mounted immediately behind the incoming channel 16 in such a matter that the driving force of the wind will strike approximately an upper one third of an exposed turbine blade face (approximately 10″ by 18″ exposed through an opening in the shroud). The resultant force will initiate and maintain the rotation of the turbine 14.

The exhausting channel 18 will be comprised of a series of interconnected channels 66 that will allow the air to expand and escape through multiple exhausting channels 66. The resultant effect will be to eliminate any turbulence and back pressure that might otherwise be the result of the large volume of escaping air 54.

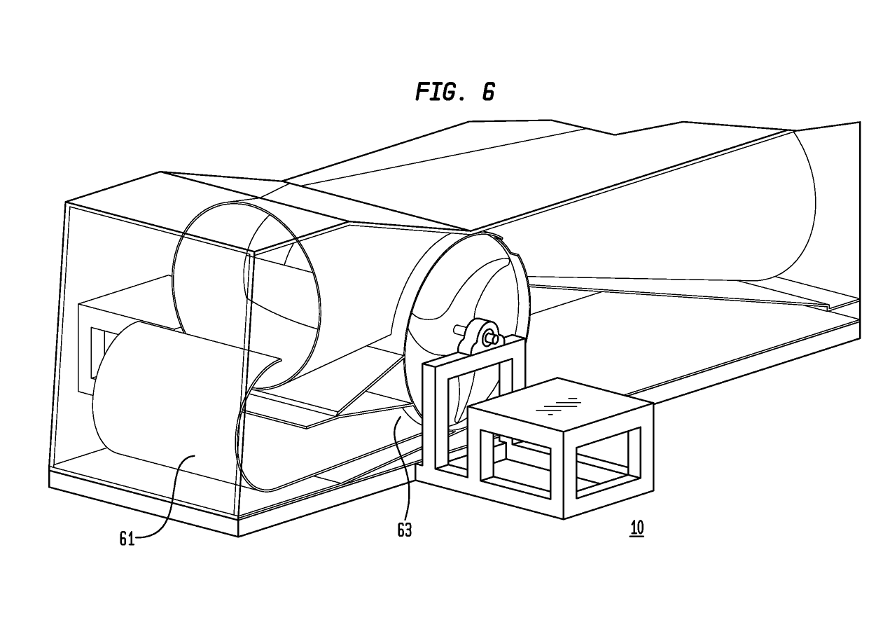

As shown in FIG. 6, a wind diverter 61 may be used in conjunction with the exhausting channel 18. The wind diverter 61 allows a portion of the exhausted air flow 54 to be recovered and recycled back into the turbine housing 12 through a separate opening 63. The volume of air from the wind diverter 61 is roughly ⅓ that of the original air flow and the flow must be equal to or greater than the primary source to add value.

The device may also have specific controls 38 to avoid overheating and control variant electrical discharge.

As shown in FIG. 3, the disclosed technology may comprise two main mounting components: an air frame 34 and a motor frame 32a-b. The airframe 34 intersects the motor frame 32a-b at ninety degrees. The common component in both the airframe 34 and motor frame 32a-b is the turbine 14 as shown in FIG. 1. The turbine 14 may be connected directly to the motor/generator 30a-b through a shaft 24 that allows for the conversion of wind power to mechanical power due to the wind power being created by the airframe providing sufficient torque and revolutions per minute to provide for push through for the motors to become generators.

Other components of the system may include programmable logic controllers, variable transformers, regenerative drives, phase converters, electrical contactors, industrial inverters, transfer switches, disconnects, 3 pole motor/generators, 4 pole polyphase induction motor/generators, 4 pole polyphase induction squirrel cage motor/generators and capacitor banks

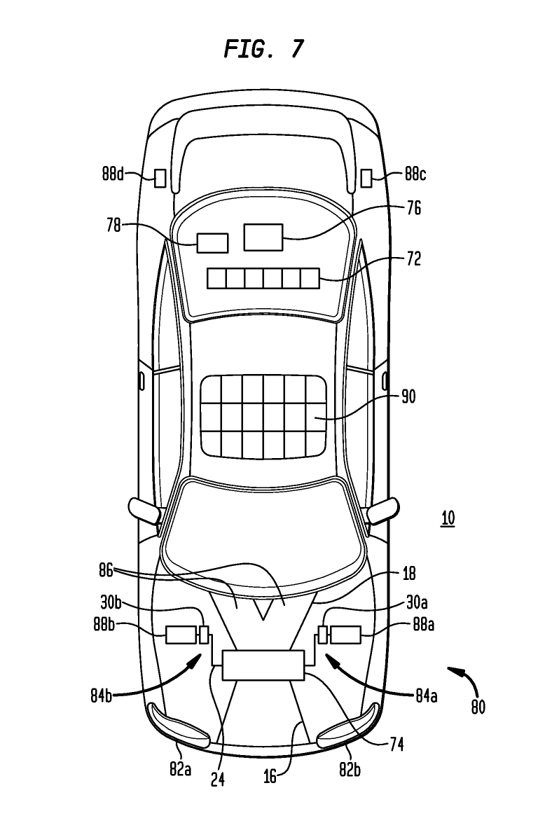

As shown in FIG. 7, the wind force driven system may be utilized to power a vehicle 70 directly or can be incorporated into a vehicle's battery system 72. The turbine 74, which can be located in various places within vehicles, will provide sufficient mechanical (kinetic) energy through rotation that when connected to an electrical production device creates sufficient electrical power to recharge a battery or batteries 72, thereby, extending the distance that an electric powered vehicle 70 can achieve prior to standard recharge methods. The vehicle 70 that incorporates the wind force turbine can be of any size manufactured for any purpose. The efficiency of the system will vary dependent upon the electrical requirements of the vehicle.

The wind force driven turbine can also be incorporated into tractor trailer configurations (not shown) where the trailer requires electrical power for refrigeration. The wind force driven turbine is a single source wind power requirement that is provided by the vehicle moving forward. The wind power can be increased by the incorporation of wind channels that create the appropriate wind flow and wind direction to maximize the mass torque centripetal force needed for the electrical generation device that is employed in the system. The wind force turbine can be connected directly through its shaft or indirectly through pulley devices to the electric power producing device. The electric power producing device can be either an alternator or Tesla polyphase type designed wheel hub motors.

In order to avoid electrical flux or flow interruption the wind force driven system can be connected to a capacitor system 76 that allows for steady recharge of the battery or batteries 72. If more than one battery 72 is in the electrical vehicle system, an electrical control switch device 78 can be included to allow for the electrical energy to be directed to the appropriate battery.

When used in a vehicle 70, the system 10 will begin producing electricity when the vehicle 70 attains a forward speed of approximately 20-35 mph and will attain optimum output above 50 mph (1800 Turbine RPM). Although these speeds are dependent on the weight of the turbine 14, the dimensions of the turbine 14, the resistance of the generator bearings, the torque of the motors/alternators 30a-b and the wind channel design 16, 18. Through testing, it has been determined that the low end speed for any commercial application is above 20 mph. The high end speed is dependent on the wind exhaust from the exhausting wind channel 18. That is, the balance of positive and negative wind forces (pressure) is dependent on the ability of the wind (air) to be released at a pressure that is lower than the pressure that would create a back force. Calculations show that the maximum wind speed over the turbine 74 is approximately 42% the speed of sound (0.42×768 mph) or 322 mph. At that point the vibration created by the wind overspeeds the turbine 74 and the turbine 74 loses any increased capability of doing more work.

The turbine 74 may be mounted in the hood 80 of the vehicle 70 and the front opening to the incoming wind channel 16 may be mounted in an area between the headlights 82a-b. The alternators 30a-b may be mounted behind the turbine and slightly below the axis of the turbine shaft 24. The alternators 30a-b may be connected via a pulley/belt system 84a-b on the opposing ends of the turbine shaft 24. The alternator/turbine pulley ratio may be, for example, a 2:1 ratio or 3:1 ratio which is based on optimum alternator output. The exhaust wind channeling system 18 will also be mounted behind the turbine 74. The exhausting channel 18 may be comprised of a series of interconnected channels 86 that will allow the air to expand and escape through openings in the hood (over windshield), beneath the floor panels and through the front wheel wells and fenders. The resultant effect will be to eliminate any turbulence and back pressure that might otherwise be the result of the large volume of escaping air.

The disclosed technology may utilize a four wheel hub motor 88a-d which may be powered from the turbine 74. These motors 88a-d serve two purposes. First, they provide propulsion for the vehicle 70 and, second, they produce additional electrical energy during deceleration (regenerative braking) The wheel hub motors 88a-d may be 46 KW wheel hub motors with approximately 244 HP with an average hourly consumption of 21.2 KW.

The motors 88a-d will provide adequate power and torque to propel a 3000-pound vehicle 70 to speeds in excess of 100 MPH. Further the vehicle 70 will be able to accelerate from 0 to 60 in less than 5 seconds. Under normal driving conditions and speeds, the vehicle will utilize approximately 21.2 Kilowatts per hour from the alternators 30a-b and/or battery pack 72.

Initial power to the motors will be supplied by a battery pack (e.g., a 53 KW lithium ion battery pack). Once the vehicle attains speeds in excess of approximately 20 MPH, the resultant amplified head wind will initiate turbine rotation, which in turn, will drive the alternators and ultimately provide the electrical power necessary to drive the automobile.

The alternators 30a-b may produce electrical energy that ranges from approximately 16 Kilowatts at 2000 RPM to 25.2 Kilowatts at its optimum RPM of 6500. At highway speeds, the turbine/alternator system will produce a surplus of approximately 4 Kilowatts per hour. This surplus will be used to operate auxiliary electrical devices, as well as for maintaining the battery packs charge.

The battery packs 72 may be located beneath the rear seats. They will consist of numerous lithium ion batteries and will have a total storage/output capacity of 53 KW. The vehicle 70 may also utilize a solar panel 90 (e.g. a 240 W rooftop solar panel having dimensions of 72″×50″) that may charge the battery pack 72 when parked, as well as supplementing the turbine 74 while driving.

Utilizing only the batteries 72, the vehicle 70 will have a range of approximately 150 miles under normal driving conditions. The batteries 72 have an expected life of approximately 10,000 cycles/recharges or 1.5 million miles before replacement becomes necessary far exceeding the average life cycle of an automobile.

In use, the start-up procedure for the unit is to first electrically energize the motor/generators 30a-b with sufficient electrical power to create fully loaded torque and 1750 rpms. After the system 10 has reached those requirements, the dampers 64 are opened and airflow with a minimum speed of 20 MPH is introduced into the turbine 74. With the correct mass torque centripetal force ratio, the wind energy will push through the breakdown torque requirement of the generators 30a-b and the generators 30a-b (e.g., polyphase induction motors) will begin to generate electricity.

For speeds under 20 MPH, a first fan may be activated at a high start-up power to power the generators. Once the first fan (not shown) achieves steady state, a second fan (not shown) may be activated.

The device can be used either with open fluid force or channeled fluid force. The device efficiency is increased when used in conjunction with a fluid channeling tunnel that compacts the fluid and directs the fluid to the tips of the blades. The generation of the fluid force can be either natural or man made.

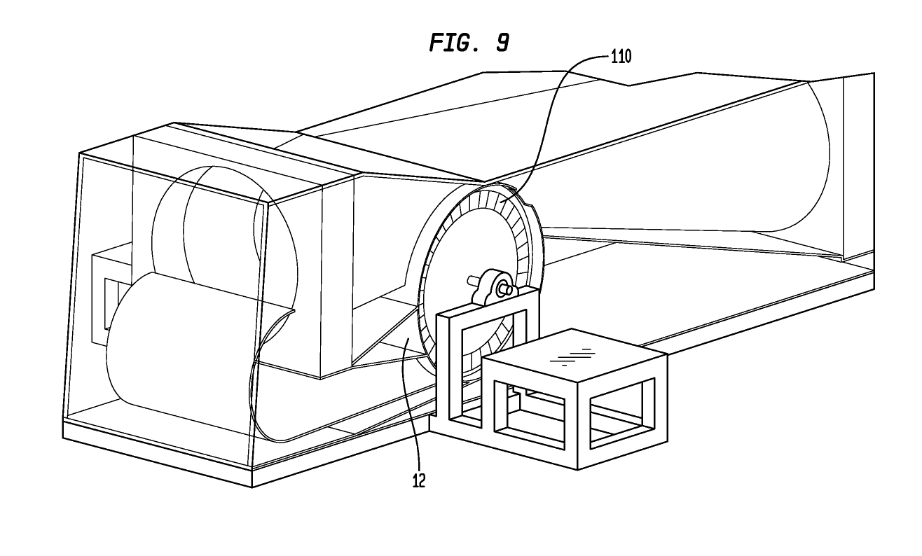

The device can be used in conjunction with other technologies such as electromagnetic generation for increased efficiency. As shown in FIG. 9, magnets 110 may be attached to wind turbine 14 and housing 12 to increase energy production.

The device is not limited to any single application. The device can be used in any vehicle or mechanism for the production of electricity. The device is generally most efficient when used in conjunction with the appropriate materials with a mass torque centripetal force ratio that is appropriate for the application.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A system for producing electrical power comprising:
a turbine, the turbine having at least two turbine blades;
a turbine housing, the housing having at least two openings, the at least two openings including a first opening and a second opening;
an incoming channel, the incoming channel directing and amplifying a flow of a working fluid at the first opening, the incoming channel being mounted in such a way that the flow of working fluid strikes an upper portion of the turbine blades; and
at least one generator being connected to the turbine for producing electrical power.

2. The system for producing electrical power as claimed in claim 1 wherein the turbine has a single rotating axis.

3. The system for producing electrical power as claimed in claim 2 wherein the blades are equally spaced around the axis.

4. The system for producing electrical power as claimed in claim 3 wherein the tips of the blades are parallel to the axis.

5. The system for producing electrical power as claimed in claim 1 wherein the blades have a length and a curvature.

6. The system for producing electrical power as claimed in claim 5 wherein the turbine blades have a backward curvature and a length of 7-21 inches.

7. The system for producing electrical power as claimed in claim 1 wherein the blades tips are weighted.

8. The system for producing electrical power as claimed in claim 1 wherein the turbine housing is cylindrical.

9. The system for producing electrical power as claimed in claim 1 further comprising:
an exhausting channel, the exhausting channel directing the flow of the working fluid from the second opening to the ambient atmosphere.

10. The system for producing electrical power as claimed in claim 9 wherein the exhaust channel is mounted in such a way that the flow of the working fluid allows the flow to expand and escape through multiple exhaust openings.

11. The system for producing electrical power as claimed in claim 1 wherein the at least one electrical generator is a 230/460 V, 60 Hz alternator.

12. The system for producing electrical power as claimed in claim 1 where the electrical generator is directly connected to the turbine.

13. The system for producing electrical power as claimed in claim 1 wherein the electrical generator is connected to the turbine via a belt/pulley system.

14. The system for producing electrical power as claimed in claim 1 wherein the electrical generator is connected to the turbine via a variable drive system.

15. The system for producing electrical power as claimed in claim 1 further comprising:
a set of dampers mechanically louvered so as to modulate the velocity and volume of the flow and deflect any excess.

16. The system for producing electrical power as claimed in claim 1 further comprising:
a set of magnets attached to the turbine and/or the turbine housing for generating electromagnetic energy.

17. The system for producing electrical power as claimed in claim 1 further comprising:
a control system for monitoring and regulating electrical power production and consumption.

18. A system for producing electrical power comprising:
a centrifugal turbine, the centrifugal turbine having a drive shaft and at least three turbine blades attached to the drive shaft, the three turbine blades being backward-curved blades; and
a turbine housing, the housing having at least two openings, the first opening receiving a flow of a working fluid and the second opening exhausting the flow of the working fluid.

19. The system for producing electrical power as claimed in claim 18 further comprising:
an incoming channel, the incoming channel directing and amplifying the flow of the working fluid at a first opening, the incoming channel being mounted in such a way that the flow of the working fluid strikes an upper portion of turbine blades.

20. The system for producing electrical power as claimed in claim 19 further comprising:
at least one generator being connected to the turbine for producing electrical power.

21. A system for producing electrical power comprising:
a turbine, the turbine having at least two turbine blades; and
a turbine housing, the housing having a first, a second and a third opening, the first opening receiving a flow of a working fluid, the second opening exhausting the flow of the working fluid; and
a flow diverter, the flow diverter directing the flow exhausted from the second opening to the third opening.

22. The system for producing electrical power as claimed in claim 21 further comprising:
an incoming channel, the incoming channel directing and amplifying the flow of the working fluid at a first opening, the incoming channel being mounted in such a way that the flow of the working fluid strikes an upper portion of turbine blades.

23. The system for producing electrical power as claimed in claim 22 further comprising:
at least one generator being connected to the turbine for producing electrical power.

24. A system for producing electrical power comprising:
a turbine, the turbine having at least two turbine blades;
a turbine housing, the turbine housing having a first opening and a second opening, the first opening receiving a flow of a working fluid, the second opening exhausting the flow of the working fluid;
an exhausting channel, the exhausting channel directing the flow of the working fluid from the second opening to the ambient atmosphere, the exhaust channel being mounted in such a way that the flow of the working fluid expands and escapes through multiple exhaust openings; and
at least one generator being connected to the turbine for producing electrical power.

25. The system for producing electrical power as claimed in claim 24 wherein the exhausting channel minimizes turbulence and back pressure associated with exhausted working fluids.

26. A system for producing electrical power in a moving vehicle comprising:
a turbine, the turbine having at least three turbine blades;
a turbine housing, the housing having at least two openings, the at least two openings including a first opening and a second opening;
an incoming channel, the incoming channel directing and amplifying working fluids at the first opening, the incoming channel being mounted in such a way that the working fluids strike an upper portion of turbine blades;
at least one generator being connected to the turbine for producing electrical power; and
mounting means for mounting the turbine, the turbine housing, the incoming channel and the generator.

27. The system for producing electrical power in a moving vehicle as claimed in claim 26 wherein the turbine and turbine housing are mounted within the vehicle near a front of the vehicle.

28. The system for producing electrical power in a moving vehicle as claimed in claim 27 wherein the incoming channel is mounted between headlights of the moving vehicle.

29. The system for producing electrical power in a moving vehicle as claimed in claim 28 wherein the at least one generator is mounted behind the turbine and turbine housing and slightly below an axis of the turbine.

30. The system for producing electrical power in a moving vehicle as claimed in claim 29 wherein the at least one generator is connected via a pulley/belt system to opposing ends of a turbine shaft.

31. The system for producing electrical power in a moving vehicle as claimed in claim 30 wherein the at least one generator and turbine have a pulley/belt ratio of 3:1.

32. The system for producing electrical power in a moving vehicle as claimed in claim 29 wherein an exhaust channel is mounted behind the turbine and turbine housing.

33. The system for producing electrical power in a moving vehicle as claimed in claim 32 wherein the exhausting channel includes a series of interconnected channels that allows the air to expand and escape through the interconnected channels.

34. The system for producing electrical power in a moving vehicle as claimed in claim 33 wherein the interconnected channels open near a vehicle windshield, beneath floor panels and through front wheel wells and fenders.

35. The system for producing electrical power in a moving vehicle as claimed in claim 34 wherein the exhausting channel eliminates any turbulence and back pressure that might otherwise be a result of exhausting an airflow.

36. The system for producing electrical power in a moving vehicle as claimed in claim 27 further comprising:
a set of wheel hub motors for propelling the vehicle.

37. The system for producing electrical power in a moving vehicle as claimed in claim 36 wherein the wheel hub motors include a regenerative braking system.

38. The system for producing electrical power in a moving vehicle as claimed in claim 27 further comprising:
battery packs for storing electrical power produced from the generator.

39. The system for producing electrical power in a moving vehicle as claimed in claim 27 further comprising:
solar panels attached to a roof of the vehicle for producing electricity when the vehicle is not running

40. The system for producing electrical power in a moving vehicle as claimed in claim 27 further comprising:
programmable logic controllers for controlling power consumption and generation.

41. The system for producing electrical power in a moving vehicle as claimed in claim 27 further comprising:
variable transformers, regenerative drives, phase converters, electrical contactors, industrial inverters, transfer switches, disconnects, three pole motor/generators, four pole polyphase induction motor/generators, four pole polyphase induction squirrel cage motor/generators, capacitor banks and combinations thereof.

42. A method for producing electrical power comprising the steps of:
directing and amplifying a flow of a working fluid into a turbine housing, the flow of working fluid striking an upper portion of turbine blades; and
producing electrical power from a rotation of the turbine blades.

43. A method for producing electrical power as claimed in claim 43 further comprising the step of:
exhausting and expanding the flow of the working fluid out of the turbine housing.
